(19) United States
(12) Patent Application Publication
(10) Pub. No.: US 2007/0174849 A1
(43) Pub. Date: Jul. 26, 2007

(54) Non-disruptive multipath device driver update system and method

(76) Inventors: Yan Man Cheung, San Jose, CA (US); Jeinay Nanji Dedhia, San Jose, CA (US); Darshan Jayantilal Vora, San Jose, CA (US); Rong Zeng, San Jose, CA (US)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/330,484

(22) Filed: Jan. 12, 2006

(51) Int. Cl. G06F 9/46

(52) U.S. Cl. 719/321

(57) ABSTRACT

A non-disruptive multipath device driver update system and method are provided. An additional layer device driver is provided between applications running on host system and the multipath device driver such that when an upgrade or update operation is performed on a multipath device driver, the layer device driver redirects I/O operation requests through a standby multipath device driver or an operating system disk I/O device driver. The multipath device driver may then be unloaded and updated without having to experience any downtime since I/O operation requests may still be issued by the applications and redirected around the unloaded multipath device driver. Once the multipath device driver is updated, I/O operation requests may be again routed to the updated multipath device driver and the system may operate in a normal fashion.

### BACKGROUND

1. Technical Field

The present application relates generally to an improved data processing system and method. More specifically, the present application is directed to a non-disruptive system and method for generating backup sets to a specific point in time.

2. Description of Related Art

Data availability and bottlenecks become a great concern when a system has several storage devices distributed across multiple input/output (I/O) adapters. For example, if an I/O adapter fails, then access to the storage devices connected to the failed adapter is lost. Such failures may cause catastrophic problems for organizations that rely heavily on their ability to access data stored on storage devices, e.g., electronic businesses, Internet websites, and the like.

Multipathing helps to prevent such situations from occurring. Multipathing takes advantage of multiple paths between a host system and the storage devices present in a storage system coupled to the host system. When an adapter fails, the system automatically reroutes I/O operations to another available path to the required storage device. Thus, if one adapter fails, I/O operations may be rerouted through another adapter so that the I/O operation may reach the required storage device, just through a different path.

Such rerouting also allows for balancing of the I/O loads on multiple paths. If a particular path is experiencing heavy I/O loads, subsequent I/O operations may be rerouted through another path that is less heavily loaded so as to balance the loads on all paths. Such load balancing helps to prevent I/O bottlenecks, i.e. I/O operations experiencing large delays while waiting for earlier I/O operations to be processed through a particular path.

Typically, systems employing multipathing make use of multipathing device drivers, such as the Subsystem Device Driver (SDD), available from International Business Machines, Inc. or Armonk, N.Y. SDD is a pseudo device driver designed to support multipathing that resides in a host system with a native disk device driver. SDD provides enhanced data availability, dynamic I/O load balancing across multiple paths, and automatic path failover protection. I/O operations are sent first to the SDD and then proceed from the SDD to the host disk driver after path selection by the SDD. When an active path experiences heavy loads or a failure, the SDD switches to another path dynamically. This path switching capability in SDD prevents a single failing adapter on a host system from disrupting data access.

In the fast evolving storage area network environment of today, it is very common to require upgrades to a multipathing device driver in order to incorporate fixes for known defects, new features, or to add support for new storage devices. In the current technology, it is necessary to stop all I/O operations and shutdown the applications accessing the multipathing device driver during the upgrade process. The multipathing device driver may then be upgraded, the applications restarted, and the I/O operations reissued. This scheduled downtime is disruptive to the user's business. This disruption is even more troublesome in the enterprise environment in which many hosts are utilized and each host must have its multipathing device driver upgraded.

### SUMMARY

In view of the above, it would be beneficial to have a mechanism for performing upgrades or updates to a multipath device driver without incurring the system downtime experienced by the current technology. The mechanisms of the illustrative embodiments provide such functionality by providing an additional layer of indirection between applications and a multipath device driver.

When an upgrade or update operation is performed on a multipath device driver, this additional layer, i.e. a layer device driver, redirects I/O operation requests through a standby multipath device driver or an operating system disk device driver. The multipath device driver may then be unloaded and updated without having to experience any downtime since I/O operation requests may still be issued by the applications and redirected around the unloaded multipath device driver. Once the multipath device driver is updated, I/O operation requests may be again routed to the updated multipath device driver and the system may operate in a normal fashion. During normal operation, the additional layer of the illustrative embodiment acts as a pass-through entity that passes I/O operation requests directly to the multipath device driver without redirection.

In one illustrative embodiment, a computer program product in a computer usable medium is provided. The computer program product comprises a computer readable program which, when executed by a computing device, causes the computing device to receive, in a layer device driver, an input/output (I/O) operation request from an application and route the I/O operation request from the layer device driver to a multipath device driver when the layer device driver is operating in a first mode of operation. The I/O operation request is routed from the layer device driver to a device driver different from the multipath device driver when the layer device driver is operating in a second mode of operation. The layer device driver may be switched from the first mode of operation to the second mode of operation in order to perform an update operation on the multipath device driver.

The computer readable program may further cause the computing device to receive an instruction to initiate an update operation on the multipath device driver and switch the layer device driver from the first mode of operation to the second mode of operation. The multipath device driver may be unloaded and I/O operation requests may be routed from the application in accordance with the second mode of operation.

The computer readable program may further cause the computing device to perform an update operation on the multipath device driver to generate an updated multipath device driver. The updated multipath device driver may be loaded and the layer device driver may switch from the second mode of operation to the first mode of operation.

The device driver different from the multipath device driver may be an operating system storage device driver. Alternatively, the device driver different from the multipath device driver may be a standby multipath device driver.

The computer readable program may further causes the computing device to retrieve path-logical unit number (LUN) information from a path-LUN data structure maintained by the multipath device driver and select a working path for routing of I/O operation requests, while operating in the second mode of operation, based on the path-LUN information. I/O operation requests may be routed from the application using the selected working path.

In a further illustrative embodiment, an apparatus for routing I/O operation requests is provided. The apparatus may comprise a processor and a memory coupled to the processor. The memory may contain instructions which, when executed by the processor, cause the processor to perform the various functions described previously with regard to the computer program product.

Moreover, in another illustrative embodiment, a method is provided, in a data processing system, for routing input/output (I/O) requests. This method may comprise receiving, in a layer device driver, an input/output (I/O) operation request from an application and routing the I/O operation request from the layer device driver to a multipath device driver when the layer device driver is operating in a first mode of operation. The I/O operation request may be routed from the layer device driver to an device driver different from the multipath device driver when the layer device driver is operating in a second mode of operation. The method may provide further functionality similar to that described above with regard to the computer program product.

These and other features and advantages of the present invention will be described in, or will become apparent to those of ordinary skill in the art in view of, the following detailed description of the exemplary embodiments of the present invention.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram of a data processing system architecture in which exemplary aspects of an illustrative embodiment may be implemented;

FIG. 2 is an exemplary block diagram illustrating an interface of a multipath device driver with an application and storage device drivers in accordance with a known architecture;

FIG. 3 is an exemplary block diagram illustrating an interface of a layer device driver and multipath device driver with application and storage device drivers in accordance with one illustrative embodiment;

FIG. 4 illustrates an operation of an illustrative embodiment when redirecting input/output (I/O) operations through a operating system disk device driver during a multipath device driver update operation;

FIG. 5 illustrates an operation of an illustrative embodiment when redirecting I/O operation requests through a standby multipath device driver during a multipath device driver update operation; and

FIG. 6 is a flowchart outlining an exemplary operation for performing a multipath device driver update operation in accordance with an illustrative embodiment.

### DETAILED DESCRIPTION OF THE PREFERRED EMBODIMENTS

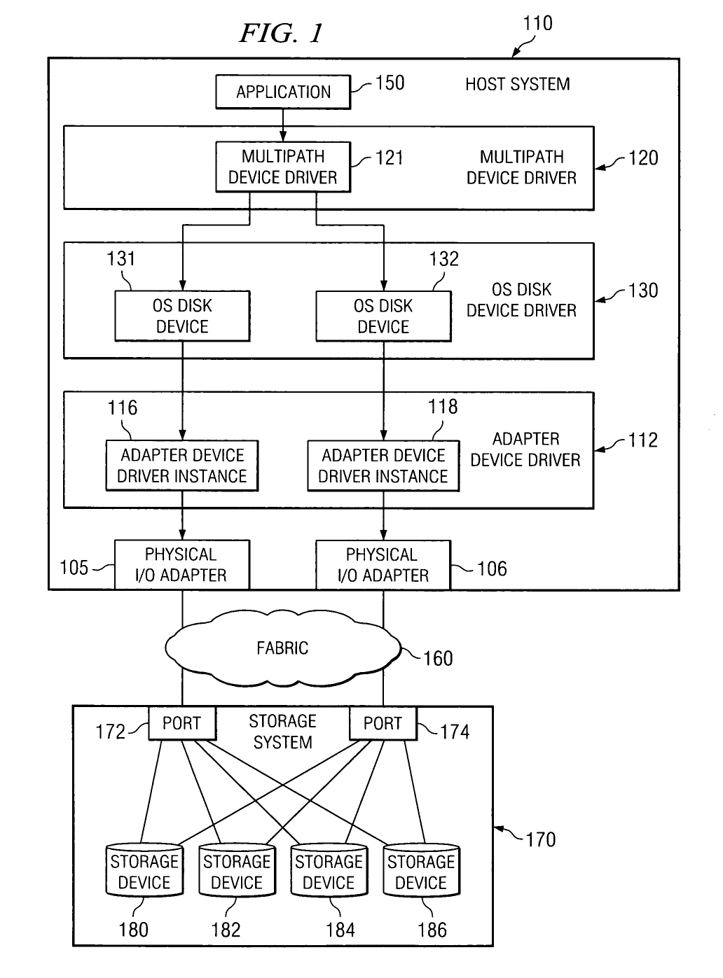

The illustrative embodiments provide mechanisms for performing updates to multipath device drivers without causing downtime of applications using the multipath device drivers. The mechanisms of the illustrative embodiments may be implemented in any data processing system in which multipath device drivers are utilized. FIG. 1 hereafter provides one example of a data processing system architecture in which the mechanisms of the illustrative embodiments may be implemented. It should be appreciated, however, that FIG. 1 is only exemplary and is not intended to state or imply any limitation as to the particular architectures in which the exemplary aspects of the illustrative embodiments may be implemented. Many modifications to the architecture depicted in FIG. 1 may be made without departing from the spirit and scope of the present invention.

FIG. 1 is an exemplary block diagram of a data processing system architecture in which exemplary aspects of an illustrative embodiment may be implemented. As shown in FIG. 1, a host system 110 is provided with a plurality of input/output (I/O) adapters 105 and 106. Each adapter 105 and 106 has associated instances 116 and 118 of an adapter device driver 112 running on the host system 110 through which I/O operation requests may be submitted to the I/O adapters 105 and 106. In addition, the host system 110 runs a multipath device driver 120 and an operating system disk device driver 130 that provides operating system disk devices 131 and 132, which are instances of the operating system disk device driver 130 for each of the I/O adapter driver instances 116 and 118. The operating system disk device driver 130 provides a mechanism for communicating I/O operation requests from multipath device 121 running on the host system 110, to the I/O adapter driver instances 116 and 118 through the corresponding I/O adapter device driver 112.

The I/O adapters 105 and 106 may be connected to a fabric 160 which may comprise one or more networks or data processing devices, routers, switches, and the like, through which the I/O operation requests may be routed. The I/O operation requests are routed through the fabric 160 to an appropriate port 172, 174 of a storage system 170. The storage system 170 comprises a plurality of storage devices 180-186. I/O operation requests are sent to these storage devices 180-186 via the ports 172, 174 in a known manner. As shown, each port 172 and 174 provides a separate pathway for accessing each of the storage devices 180-186. Thus, in the depicted example, there are two pathways for accessing each storage device 180-186.

Moreover, there are multiple paths from the application 150 to the storage devices 180-186 by way of the multiple I/O adapters 105 and 106 and the multiple ports 172 and 174. The particular path chosen for accessing the storage devices 180-186 is determined by the multipath device driver 120 running on host system 110. The multipath device driver 120 may add appropriate routing information to I/O operation requests to ensure proper routing of the I/O operation requests through the selected path to a target storage device 180-186.

In operation, when the application 150 sends an I/O operation request to the multipath device driver 120, the multipath device driver 120 selects a path for the I/O operation request and sends the I/O operation request to the appropriate operating system disk device 131 and 132. The operating system disk device driver 130 converts the I/O operation request from the application 150 into one or more appropriate I/O command(s) for the target storage device 180-186. The operating system disk device driver 130 sends the I/O command(s) to an associated I/O adapter device driver instance 116 and 118 via the operating system disk devices 131 and 132. The adapter device driver 112 is used as an interface to the I/O adapter hardware which transmits the I/O operation request to the appropriate port 172, 174 of the storage system 170.

In one illustrative embodiment, the I/O operation request specifies a logical unit number (LUN) of the storage device 180-186 that is the target of the I/O operation request. This LUN is used to convert the I/O request into I/O commands for the particular type of storage device and to route the I/O commands from the port 172, 174 to the appropriate storage device 180-186.

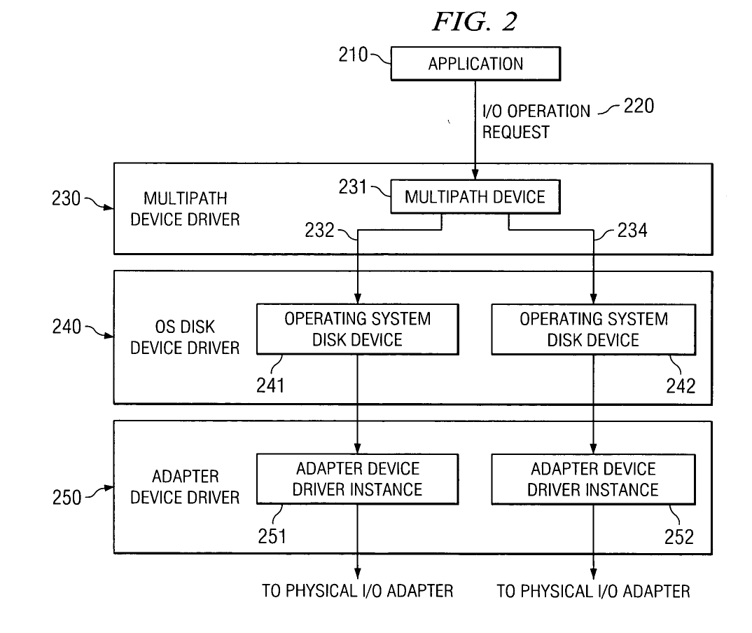

FIG. 2 is an exemplary block diagram illustrating an interface of a multipath device driver with an application and storage device drivers in accordance with a known architecture. As shown in FIG. 2, an application 210 sends an I/O operation request 220 to a multipath device driver 230, of which multipath device 231 is an instance. The multipath device 231 has a plurality of paths 232, 234 from which a path may be selected for the particular I/O operation request 220. The multipath device 231 selects an appropriate path 232, 234 and routes the I/O operation request down the selected path to the operating system disk device 241, 242, which are instances of the operating system disk device driver 240. The operating system disk device 240, 242, in turn, provides the I/O operation request to an I/O adapter device 251, 252, which is an instance of the adapter device driver 250 and operates to transmit the I/O operation request to an appropriate port of a storage system via an associated I/O adapter (not shown in FIG. 2).

The multipath device 231 may select one of the paths 232, 234 based on current conditions of the paths 232, 234. For example, if an adapter associated with path 232 has failed, then the multipath device 231 will select the path 234 for routing of the I/O operation request. If an adapter associated with path 234 is experiencing heavy I/O operation loads, then the multipath device 231 may select path 232 if the adapter associated with path 232 has a relatively lower I/O operation load in order to balance the loads across both adapters.

Such multipath operations are generally known in the art and are performed, for example, by the Subsystem Device Driver (SDD) available from International Business Machines, Inc., as previously mentioned above. The illustrative embodiments herein add a layer device driver between the application 210 and the multipath device driver 230 for avoiding downtime of the application 210 when performing updates to the multipath device driver 230. This layer device driver is notified of when a multipath device driver update operation is being initiated and serves to redirect I/O operation request from the multipath device driver 230 to an operating system disk device driver or a standby multipath device driver. In this way, the application 210 may continue to send I/O operation requests to the storage system while the update to the multipath device driver 230 is being performed. Thereby, times of inoperability of the application 210 are avoided.

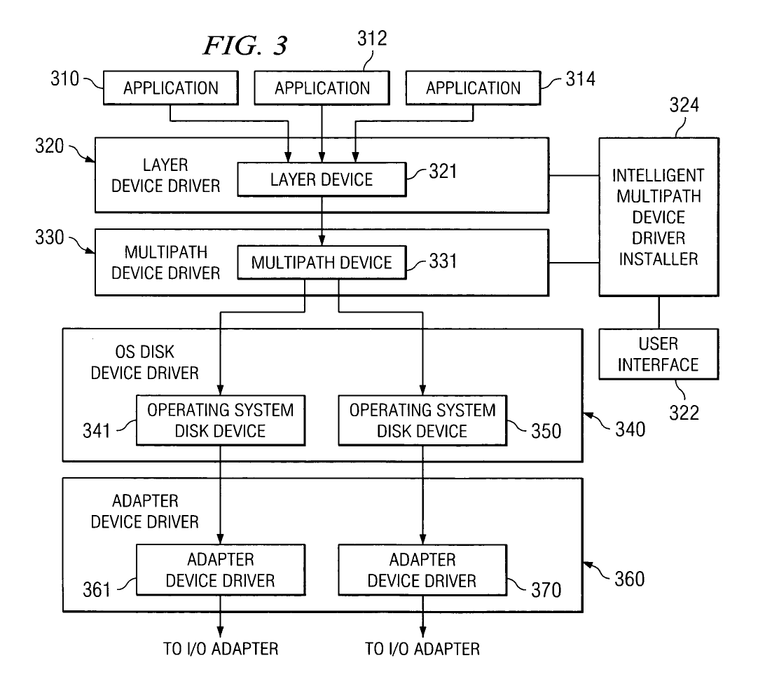

FIG. 3 is an exemplary block diagram illustrating an interface of a layer device driver and multipath device driver with application and storage device drivers in accordance with one illustrative embodiment. As shown in FIG. 3, the layer device driver 320 has an interface to applications 310, 312 and 314 and to multipath device driver 330. The layer device 321 is an instance of the layer device driver 320. The applications 310, 312 and 314 open and perform I/O operation requests to physical storage devices through the interface exported by the layer device 321 instead of going directly through the interface exported by the multipath device driver 330, of which multipath device 331 is an instance. As with the known multipath architecture, the multipath device driver 330 interfaces with the operating system disk devices 341, 350 which in turn interface with the I/O adapter devices 361, 370.

During normal operation, i.e. when an update to the multipath device driver 330 is not occurring or about to occur, the layer device 321 receives I/O operation requests from applications 310, 312, and 314 and directs the I/O operation requests to the multipath device 331. In this way, the features of the multipath device 331, i.e. load balancing, failover, failback, and the like, may be utilized with these I/O operation requests. When an update or upgrade operation is to be performed to the multipath device driver 330, the layer device 321 is notified to redirect I/O operation requests directly to an operating system disk device 341, 350 or to a standby multipath device driver (not shown) that may be loaded or activated when the multipath device driver update operation is initiated. After the multipath device driver 330 update or upgrade operation is complete, the layer device 321 is notified to direct I/O operation requests to the multipath device 331 with updated multipath device driver 330.

Thus, the layer device driver 320 has two modes of operation. In a first mode of operation, I/O operation requests received by the layer device driver 320 from applications 310, 312 and 314 are directed to the multipath device driver 330. This first mode of operation is essentially a “pass-through” mode of operation in that the layer device driver 320 does not perform any significant processing on the I/O operation requests. In a second mode of operation, I/O operation requests are redirected to either an operating system disk device 341, 350 or a standby multipath device. This second mode of operation is essentially a “bypass” mode of operation in that the I/O operation requests bypass the multipath device driver 330 that is being updated or upgraded.

The layer device driver 320 interacts with an intelligent multipath device driver installer 324. The intelligent multipath device driver installer 324 operates to perform the necessary operations for de-installing the multipath device driver 330 so that it may be properly upgraded or updated, and it also operates to re-install the multipath device driver 330 after the performance of a multipath device driver update or upgrade operation.

The intelligent multipath device driver installer 324 may provide an interface 322 to an operating system through which user commands for initiating the operation of the layer device 321 may be provided. A multipath device driver update or upgrade operation may be initiated in response to a user command or operating system generated command. For example, a user may select an icon or option through a graphical user interface that causes an appropriate command to be sent to the layer device driver 320 to initiate a multipath device driver update operation.

In a first illustrative embodiment, in response to receiving a user or operating system command to initiate a multipath device driver update or upgrade operation, the intelligent multipath device driver installer 324 selects one of a plurality of working paths for each LUN supported by the layer device driver 320, and sends information to the layer device driver 320 through I/O control commands (IOCTLs) to thereby inform the layer device driver 320 of which working path will be used for all I/O operation requests during the multipath device driver update or upgrade operation.

A path-LUN data structure is stored inside the multipath device driver's kernel memory (for example, in the SDD). The intelligent multipath device driver installer 324 may obtain the information from the path-LUN data structure using existing SDD IOCTL commands, for example, in order to determine which working path will be used for I/O operation requests during the multipath device driver update operation.

For example, the intelligent multipath device driver installer 324 may take a snap shot of the structure of the current multipath device driver (for example, vpath in SDD) and the operating system storage device driver instances (for example, hdisk on AIX) for reach multipath device driver instance. Such a snap shot may take the form vpath0=hdisk22 hdisk37 hdisk92 hdisk107, for example.

The intelligent multipath device driver installer 324 may then select one operating system storage device driver instance (e.g., hdisk) from the multiple operating system storage device driver instances. The selection may be, for example, a random selection based on certain criteria, such as a hdisk with the least amount of I/O error in the past, or the like. The selected operating system storage device driver instance is then stored in a data structure of the intelligent multipath device driver installer 324.

The intelligent multipath device driver installer 324 then sends IOCTLs to the layer device driver 320 to cause the layer device driver 320 to switch from the first mode of operation to the second mode of operation and to inform the layer device driver 320 of the selected operating system storage device driver instance. An example data structure of an IOCTL that may be used in this regard is as follows:

| | | |
|---|---|---|
| { | | |
| int | compcode; | |
| dev_t | layerdevice; | /*Input: layer device |
| | | instance identifier*/ |
| dev_t | vpath_name; | /*Input: multipath device |
| | | instance's identifier*/ |
| dev_t | hdisk_name; | /*Input: OS device instance's |
| | | Identifier*/ |
| int | flag; | /*Input: this flag specifies |
| | | whether layer device driver |
| | | needs to switch I/O from |
| | | multipath device driver (SDD) to |
| | | OS device driver or vice versa*/ |

} dd_ioc_updatedriver_t;

Once the layer device driver receives the IOCTL from the intelligent multipath device driver installer 324, it will stop sending I/O operation requests to the multipath device driver instance (e.g., vpath) and will operate in the second mode of operation.

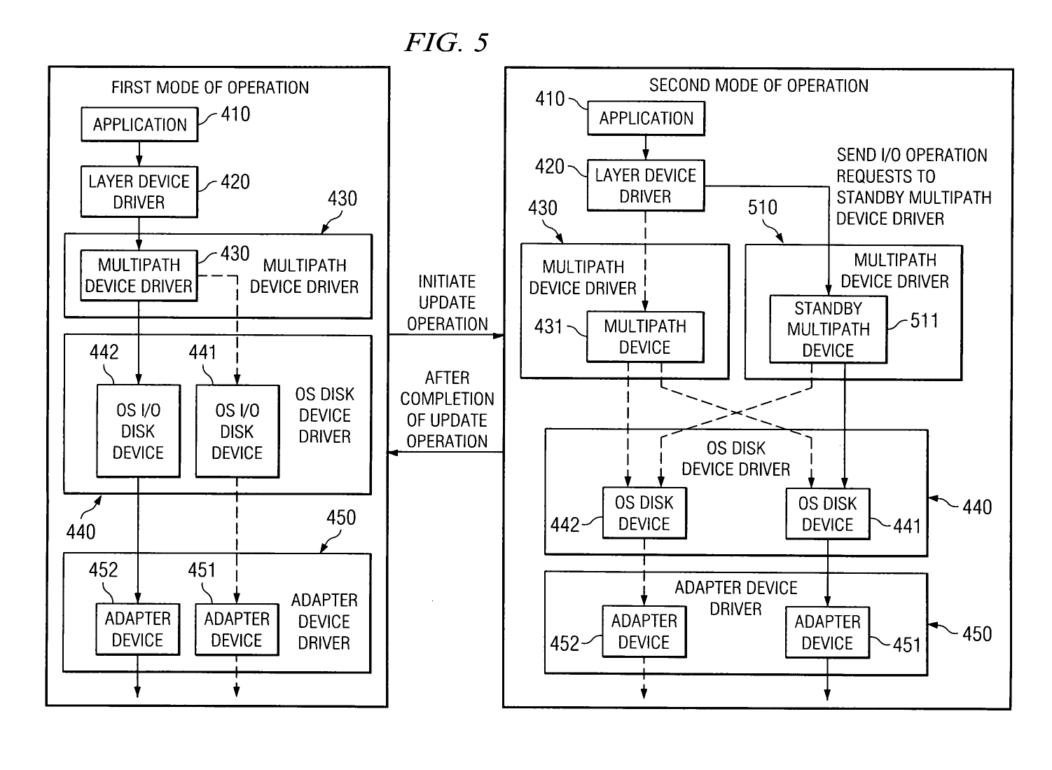

In the second mode of operation, in a first illustrative embodiment, the I/O operation requests are redirected to the selected operating system storage device driver instance. In a second illustrative embodiment, I/O operation requests may be redirected to a selected standby multipath device driver. In such a case, in the above IOCTL data structure, the dev_t hdisk_name may be replaced with dev_t mpath_name to identify a standby multipath device driver instance to which I/O operation requests are to be redirected, for example. The selected standby multipath device driver instance may be stored in the data structure of the intelligent multipath device driver installer 324 in a similar manner as discussed above with regard to the operating system storage device driver instance. In such a case, the snap shot that is generated by the intelligent multipath device driver installer 324 may be, for example, a snap shot of the relationship between the multipath device driver and the standby multipath device driver instance for each logical unit number (LUN) based on the LUN's serial number (e.g., vpath0=mpath0. More detail regarding the redirection of I/O operation requests to a standby multipath device driver will be provided hereafter with reference to FIG. 5.

At this point, the intelligent multipath device driver installer 324 may send an IOCTL periodically to the multipath device driver 330 to poll the I/O statistics of the multipath device 331. The data provided by multipath device driver 330 includes outstanding I/Os sent by the multipath device driver 330 to the operating system disk device 341, 350, and queued I/Os within multiple path device driver 330. Once the data provided by multipath device driver 330 indicates that there is no more queued I/Os within the multipath device driver 330 and there is no outstanding I/Os (which means all I/Os sent by multipath device driver 330 to the operating system disk device 341, 350 have returned), layer device driver 320 may close all the multipath devices 331 and un-configure and remove them. The intelligent multipath device driver installer 324 may then start the upgrade or update process, based on the parameters provided from user input and the operating system environment to upload the new multipath device driver. Once the upgrade or update process is finished, the intelligent installer will then configure the multipath devices.

Once the multipath device driver update or upgrade operation is completed, the intelligent multipath device driver installer 324 sends IOCTLs to the layer device driver 320 to switch the operation of the layer device driver 320 from the second mode of operation back to the first mode of operation. As a result, I/O operation requests will be directed back to the updated or upgraded multipath device driver 330 and operation may continue in a normal fashion until a next update or upgrade operation is to be performed.

For example, once the update operation is complete, the intelligent multipath device driver installer 324 may take another snap shot of the structure of the current multipath device driver (e.g., vpath in SDD) and the operating system storage device driver instances (e.g., hdisk on AIX). In the alternative embodiment using a standby multipath device driver, a similar snap shot may be obtained for the relationship between the multipath device driver and the standby multipath device driver for each LUN, as described previously.

The intelligent multipath device driver installer 324 may then find the new multipath device driver instance which corresponds to each previously selected operating system device driver instance that is stored in the data structure of the intelligent multipath device driver installer 324. The intelligent multipath device driver installer 324 may then send information which includes the selected multipath device driver instance (e.g., vpath) to the layer device driver 320 through the same IOCTL used before. Once the layer device driver 320 receives this IOCTL, it will stop sending I/O operation request to the selected operating system device driver instance (e.g., hdisk) and will start sending the I/O operation requests to the multipath device driver instance (e.g., vpath).

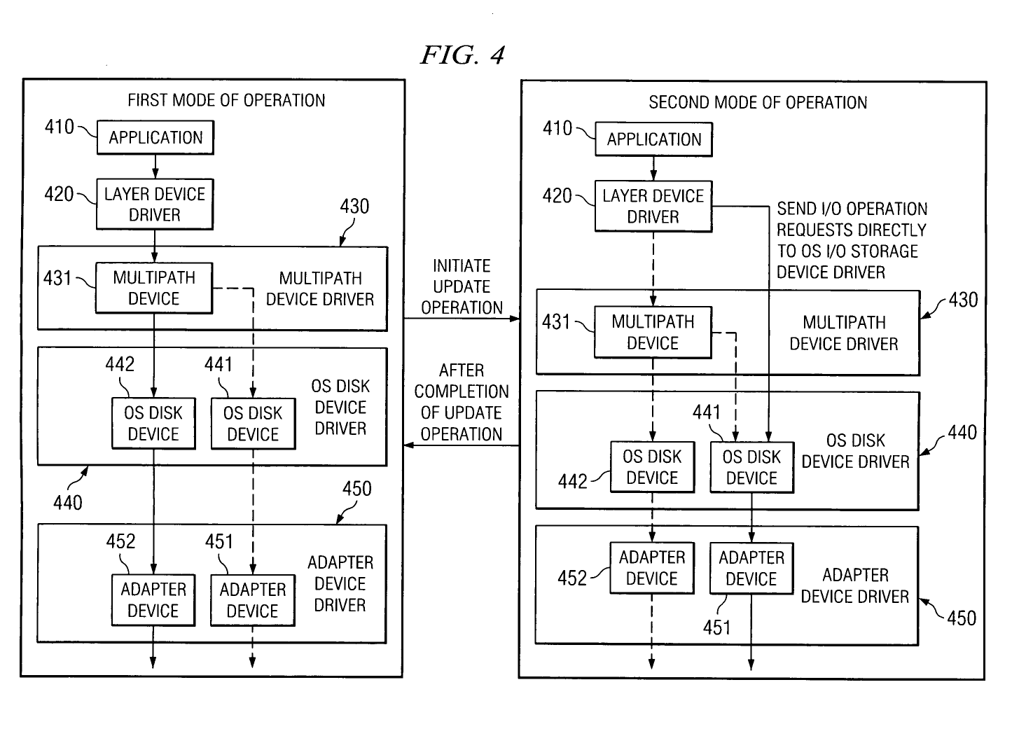

During the multipath device driver update or upgrade operation, I/O operation requests may be redirected by the layer device driver 320 from the multipath device driver 330 that is being updated or upgraded, to an operating system storage device driver or, in an alternative embodiment, a standby multipath device driver. Each of these alternative embodiments will be illustrated in FIGS. 4 and 5 hereafter. In each of these figures, the normal operation depicted is the same and is performed when an update or upgrade operation to the multipath device driver is not being performed or about to be performed. In this normal operation, I/O operation request pass from the application to the layer device driver, then to the multipath device driver which selects a path to one of the operating system disk devices. The I/O operation request is then provided to the adapter device associated with the operating system disk device which then sends the I/O operation request to the storage system through an associated I/O adapter.

FIG. 4 illustrates an operation of an illustrative embodiment when redirecting input/output (I/O) operations through an operating system disk device driver during a multipath device update operation. As shown in FIG. 4, when the layer device driver 420 is informed of a pending multipath device driver 430 update operation, the layer device driver 420 switches to the second mode of operation and an intelligent multipath device driver installer selects an alternate path for I/O operation requests from the application 410. In this example implementation, the alternate path is to direct I/O operation requests directly to the operating system disk device 441 directly, which is an instance of the operating system disk device driver 440. Thus, all I/O operation requests received while the layer device driver 420 is in the second mode of operation are redirected to the operating system disk device 441.

As a result of the above, the multipath device driver 430 may release its resources and be unloaded so that the update operation may be completed. One drawback of sending I/O operation requests directly to the operating system disk device 441 when performing the update operation is that the system is now subject to a single point of failure. That is, if the operating system disk device 441 and/or the adapter device 451 experiences a failure, then I/O operation request may not be completed since there is no other path available to the target storage devices. In order to address this single point of failure problem, in an alternative illustrative embodiment, a standby multipath device driver may be utilized to provide multipathing even while performing the update operation.

FIG. 5 illustrates an operation of an illustrative embodiment when redirecting I/O operation requests through a standby multipath device driver during a multipath device driver update operation. As shown in FIG. 5, in this illustrative embodiment, a standby multipath device drive 510 is installed in the host system which may be used when performing update operations to the multipath device driver 430. Rather than sending I/O operation requests directly to the operating system disk device 441, the layer device driver 420 sends I/O operation requests from the application 410 to the standby multipath device 511, which is an instance of the standby multipath device driver 510 when the update operation is being performed on multipath device driver 430.

The standby multipath device driver 510 operates in much the same manner as the multipath device driver 430 and in fact may be a copy of the multipath device driver 430 that is installed in the host system. Thus, the standby multipath device driver 510 selects a path, e.g., path 520 or 530, for accessing a target storage device based on current failure and loading information for the available paths. As a result, multipathing of I/O operation requests is still made available even during an update to the multipath device driver 430.

The installation of the standby multipath device driver 510 may be performed, for example, at an initialization time of the host system in which case the standby multipath device driver 510 is in an idle mode until I/O operation requests are redirected to it by the layer device driver 420. Alternatively, the standby multipath device driver 510 may be installed into the host system by the intelligent multipath device driver installer of the layer device driver 420 in response to receiving a command to initiate a multipath device driver update operation.

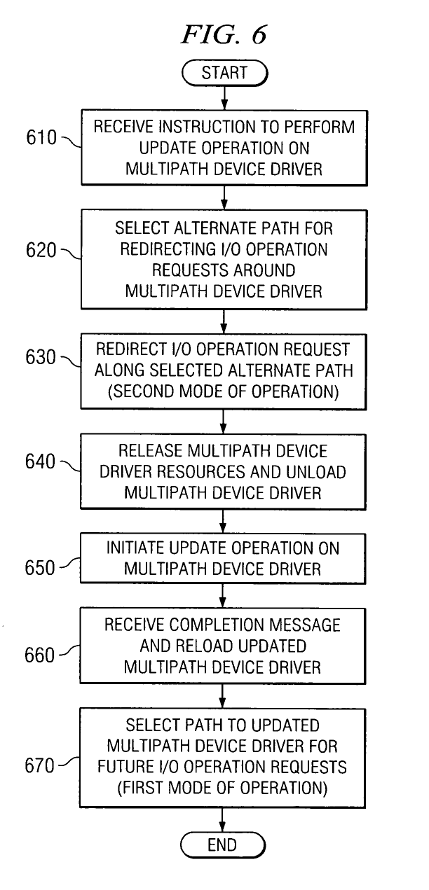

FIG. 6 is a flowchart outlining an exemplary operation for performing a multipath device driver update operation in accordance with an illustrative embodiment. It will be understood that each block of the flowchart illustration, and combinations of blocks in the flowchart illustration, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustration support combinations of means for performing the specified functions, combinations of steps for performing the specified functions and program instruction means for performing the specified functions. It will also be understood that each block of the flowchart illustration, and combinations of blocks in the flowchart illustration, can be implemented by special purpose hardware-based computer systems which perform the specified functions or steps, or by combinations of special purpose hardware and computer instructions.

The operations shown in FIG. 6 may be performed, for example, in the layer device driver that is logically positioned between the applications running on a host system and the multipath device driver. As shown in FIG. 6, the operation starts with receiving an instruction to perform an update or upgrade operation on a multipath device driver (step 610). An alternate path for redirecting I/O operation requests around the multipath device driver is selected (step 620). For example, as mentioned above, this alternate path may be to an operating system disk device or a standby multipath device, depending upon the particular implementation.

I/O operation requests received from applications are then redirected to selected alternate path (step 630). The multipath device driver is instructed to release its resources and the multipath device driver is unloaded (step 640). The update or upgrade operation is then initiated (step 650). Once the update or upgrade operation is complete, the updated multipath device driver is reloaded and a completion message is received (step 660). In response to receiving the completion message, the path to the updated multipath device driver is selected for future I/O operation requests (step 670) and the operation terminates.

Thus, the illustrative embodiments provide mechanisms for eliminating the downtime experienced with known systems when performing update or upgrade operations to multipath device drivers. The mechanisms of the illustrative embodiments add an additional layer device driver between the applications and the multipath device driver of a host system. The layer device driver operates in a “pass-through” mode when the host system is operating in a normal fashion, i.e. when an update or upgrade operation on the multipath device driver is not imminent. The layer device driver operates in a “bypass” mode when an update or upgrade operation is being performed on the multipath device driver such that I/O operation requests “bypass” the multipath device driver but are still able to access the target storage devices.

It should be noted that while the illustrative embodiments have been described in terms of disk device drivers and disk devices, the present invention is not limited to such storage media. Rather, the exemplary aspects of the illustrative embodiments may be implemented with any type of storage media including magnetic tape media, transmission media, optical storage media, and the like. The use of disk devices and disk device drivers is only meant to be exemplary and is not intended to state or imply any limitation with regard to the media with which the mechanism of the illustrative embodiments may be utilized.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer program product in a computer usable medium comprising a computer readable program which, when executed by a computing device, causes the computing device to:
receive, in a layer device driver, an input/output (I/O) operation request from an application;
route the I/O operation request from the layer device driver to a multipath device driver when the layer device driver is operating in a first mode of operation; and
route the I/O operation request from the layer device driver to a device driver different from the multipath device driver when the layer device driver is operating in a second mode of operation.

2. The computer program product of claim 1, wherein the layer device driver is switched from the first mode of operation to the second mode of operation in order to perform an update operation on the multipath device driver.

3. The computer program product of claim 1, wherein the computer readable program further causes the computing device to:
receive an instruction to initiate an update operation on the multipath device driver;
switch the layer device driver from the first mode of operation to the second mode of operation;
unload the multipath device driver; and
route I/O operation requests from the application in accordance with the second mode of operation.

4. The computer program product of claim 3, wherein the computer readable program further causes the computing device to:
perform an update operation on the multipath device driver to generate an updated multipath device driver;
load the updated multipath device driver; and
switch the layer device driver from the second mode of operation to the first mode of operation.

5. The computer program product of claim 1, wherein the device driver different from the multipath device driver is an operating system storage device driver.

6. The computer program product of claim 1, wherein the device driver different from the multipath device driver is a standby multipath device driver.

7. The computer program product of claim 1, wherein the computer readable program further causes the computing device to:
retrieve path-logical unit number (LUN) information from a path-LUN data structure maintained by the multipath device driver;
select a working path for routing of I/O operation requests, while operating in the second mode of operation, based on the path-LUN information; and
route I/O operation requests from the application using the selected working path.

8. An apparatus for routing input/output (I/O) operation requests, comprising:
a processor; and
a memory coupled to the processor, wherein the memory contains instructions, which when executed by the processor, cause the processor to implement a layer device driver and a multipath device driver, and wherein the layer device driver:
receives an input/output (I/O) operation request from an application,
routes the I/O operation request to the multipath device driver when the layer device driver is operating in a first mode of operation; and
routes the I/O operation request to a device driver different from the multipath device driver when the layer device driver is operating in a second mode of operation.

9. The apparatus of claim 8, wherein the instructions cause the processor to switch the layer device driver from the first mode of operation to the second mode of operation in order to perform an update operation on the multipath device driver.

10. The apparatus of claim 8, wherein the instructions further cause the processor to:
receive an instruction to initiate an update operation on the multipath device driver;
switch the layer device driver from the first mode of operation to the second mode of operation;
unload the multipath device driver; and
route I/O operation requests from the application in accordance with the second mode of operation.

11. The apparatus of claim 10, wherein the instructions further cause the processor to:
perform an update operation on the multipath device driver to generate an updated multipath device driver;
load the updated multipath device driver; and
switch the layer device driver from the second mode of operation to the first mode of operation.

12. The apparatus of claim 8, wherein the device driver different from the multipath device driver is an operating system storage device driver.

13. The apparatus of claim 8, wherein the device driver different from the multipath device driver is a standby multipath device driver.

14. The apparatus of claim 8, wherein the instructions further cause the processor to:
retrieve path-logical unit number (LUN) information from a path-LUN data structure maintained by the multipath device driver;
select a working path for routing of I/O operation requests, while operating in the second mode of operation, based on the path-LUN information; and
route I/O operation requests from the application using the selected working path.

15. A method, in a data processing system, for routing input/output (I/O) requests, comprising:
receiving, in a layer device driver, an input/output (I/O) operation request from an application;
routing the I/O operation request from the layer device driver to a multipath device driver when the layer device driver is operating in a first mode of operation; and
routing the I/O operation request from the layer device driver to an device driver different from the multipath device driver when the layer device driver is operating in a second mode of operation.

16. The method of claim 15, wherein the layer device driver is switched from the first mode of operation to the second mode of operation in order to perform an update operation on the multipath device driver.

17. The method of claim 15, further comprising:
receiving an instruction to initiate an update operation on the multipath device driver;
switching the layer device driver from the first mode of operation to the second mode of operation;
unloading the multipath device driver; and
routing I/O operation requests from the application in accordance with the second mode of operation.

18. The method of claim 17, further comprising:
performing an update operation on the multipath device driver to generate an updated multipath device driver;
loading the updated multipath device driver; and
switching the layer device driver from the second mode of operation to the first mode of operation.

19. The method of claim 15, wherein the device driver different from the multipath device driver is one of an operating system storage device driver or a standby multipath device driver.

20. The method of claim 15, further comprising:
retrieving path-logical unit number (LUN) information from a path-LUN data structure maintained by the multipath device driver;
selecting a working path for routing of I/O operation requests, while operating in the second mode of operation, based on the path-LUN information; and
routing I/O operation requests from the application using the selected working path.
